(19) United States
(12) Patent Application Publication
(10) Pub. No.: US 2025/0183331 A1
(43) Pub. Date: Jun. 5, 2025

(54) ELECTRICAL CONNECTION ASSEMBLY, AND METHOD FOR MAKING ELECTRICAL CONTACT AND FOR HEATING A BIPOLAR PLATE OF A FUEL CELL

(71) Applicant: Schaeffler Technologies AG & Co. KG, Herzogenaurach (DE)

(72) Inventors: Felix Altenburg, London (GB); Simon Schlirf, Erlangen (DE)

(73) Assignee: Schaeffler Technologies AG & Co. KG, Herzogenaurach (DE)

(21) Appl. No.: 18/844,387

(22) PCT Filed: Feb. 7, 2023
(86) PCT No.: PCT/DE2023/100096

§ 371 Date: Sep. 6, 2024

(30) Foreign Application Priority Data
Mar. 9, 2022 (DE) 10 2022 105 470.5

(51) Int. Cl. H01M 8/0267; H01M 8/04007; H01M 8/04701

(52) U.S. Cl. CPC H01M 8/0267; H01M 8/04037; H01M 8/04731; H01M 2200/105; H01M 2250/20

(57) ABSTRACT

An electrical connection assembly for a bipolar plate of a fuel cell includes at least one bimetal element connected to the bipolar plate, an NTC heating element, and an electrically conductive plug connector element provided for placement on the bipolar plate. When the plug connector element is plugged on the bipolar plate an electrically conductive connection between the bipolar plate and the plug connector element is established by the NTC heating element and a connection connected electrically in parallel to the NTC heating element is established by the bimetal element only in a predetermined temperature range.

### CROSS-REFERENCE TO RELATED APPLICATIONS

This application is the U.S. National Phase of PCT Appln. No. PCT/DE2023/100096 filed Feb. 7, 2023, which claims priority to DE 10 2022 105 470.5 filed Mar. 9, 2022, the entire disclosures of which are incorporated by reference herein.

### TECHNICAL FIELD

The disclosure relates to an electrical connection arrangement for a bipolar plate of a fuel cell, which is intended in particular for use in a motor vehicle. The disclosure also relates to a method for electrically contacting and heating a bipolar plate of a fuel cell.

### BACKGROUND

A fuel cell system intended for use in a motor vehicle is disclosed, for example, in EP 1 490 923 B1. This disclosure concerns a fuel cell system with freeze protection. As a measure to prevent water from freezing, it is intended therein to drain the water after the fuel cell has been switched off. Changes in the outside air temperature are also taken into account during operation of the known fuel cell system, wherein a sensor is provided for this purpose, using which the outside air temperature is measured. A water tank of the fuel cell system according to EP 1 490 923 B1 is equipped with a heating device.

Other fuel cell systems with heating devices are known, for example, from the documents US 2003/0 162 063 A1, US 2016/0 211 535 A1 and EP 1 414 090 B1. In these cases, components of the respective fuel cell system, including a heat exchanger, are located inside a housing, which can be designed as a heat protection element. The heating of a fuel cell using a catalytic heating device is proposed in JP H7-169 476 A.

A bipolar plate of a fuel cell described in U.S. Pat. No. 8,377,609 B2 delimits various flow channels. An NTC (negative temperature coefficient) element is provided on a surface of the bipolar plate, which allows for a coolant to be heated.

DE 10 2018 210 193 A1 discloses a method for starting a fuel cell device in a motor vehicle. The starting process comprises the recirculation of a gas mixture present in an anode circuit of a fuel cell stack before fuel is introduced into the fuel cell stack through an anode supply line. The duration of the recirculation should be 1 to 15 seconds, for example.

DE 10 2005 004 388 A1 describes a so-called wake-up strategy for vehicles with fuel cells. This strategy involves flushing a fuel cell stack with a moisture removal medium.

### SUMMARY

The disclosure is based on the object of achieving advances over the aforementioned prior art with regard to the reliable operation of fuel cells under a wide range of ambient conditions, in particular fluctuating temperatures.

According to the disclosure, this object is achieved by an electrical connection arrangement provided for contacting a bipolar plate of a fuel cell, having the features described herein. The object is also achieved by a method for electrically contacting and heating a bipolar plate of a fuel cell described herein. The embodiments and advantages of the disclosure explained below in connection with the contacting and heating method also apply, mutatis mutandis, to the device, i.e., to the electrical connection arrangement, and vice versa.

The electrical connection arrangement comprises at least one bimetallic element connected to a bipolar plate of a fuel cell stack, an NTC heater element, and an electrically conductive plug connector element provided for placement on the bipolar plate, wherein an electrically conductive connection is established between the bipolar plate and the plug connector element via the NTC heater element when the plug connector element is plugged onto the bipolar plate. A connection connected electrically in parallel with the NTC heater element is established only in a predetermined temperature range via the bimetallic element.

Thus, the heating output fed into the bipolar plate is controlled in two ways that complement one another, although they act in an opposing manner—continuously in one case and discontinuously in the other: First, the NTC (negative temperature coefficient) heater element ensures that the higher the temperature, the higher the thermal output due to the fact that the resistance decreases as the temperature rises. The reduced heating output at low temperatures prevents overloading of components, which would be conceivable due to localized heat pockets. At higher temperatures, however, which are associated with increasing gas and/or liquid flows within the fuel cell stack, a higher heating output can be tolerated without the risk of damage. This higher heating output is supplied by the at least one NTC heater element until the bimetallic element switches, thereby reducing the current flow through the NTC heater element, which has a comparatively high electrical resistance, to almost zero. In particular, after the bimetallic element has established an electrically conductive connection between the bipolar plate and the plug connector element, no more than 5%, for example a maximum of 2%, of the total electric current flowing between the bipolar plate and the plug connector element is conducted through the at least one NTC heater element.

According to various possible embodiments of the connection arrangement for fuel cells according to the application, NTC heater elements are arranged on both sides of the bipolar plate inside the plug connector element. This makes it possible to realize generously dimensioned heat and current transmitting surfaces, which are effective between the bipolar plate, the heater elements and the plug connector element, with a low overall height.

Bimetallic elements switching in a temperature-dependent manner can also be arranged on both sides of the bipolar plate. In this case, each bimetallic element can have a section which is arranged between the bipolar plate and one of the two NTC heater elements. The same applies to embodiments with arrays consisting of multiple NTC heater elements. In all cases, the arrangements cach consisting of a bimetallic element acting as a switch and at least one NTC heater element can be positioned mirror-symmetrically to the center plane of the bipolar plate. The mirror symmetry makes it easy to generate uniform contacting forces, wherein the risk of misalignment of the plug connector element during assembly is also eliminated.

Each of the bimetallic elements, which are arranged mirror-symmetrically to one another and, in particular, provided in the form of plates or strips, can have a deflectable section provided for contacting an inner surface of the plug connector element. When this section is deflected, i.e., in a higher temperature range, an approximately point-shaped, linear or flat contact can be established between the bimetallic element and the plug connector element. The deflectable sections of the bimetallic elements can terminate flush with an edge of the bipolar plate. This applies in particular in the state in which the bimetallic elements are completely spaced apart from the plug connector element, i.e., in the lower temperature range. In particular, the bipolar plate is a profiled sheet which can be made up of two half-sheets lying on top of one another and joined together.

With regard to the general possibilities of using NTC elements and/or bimetallic elements in connectors of electrical systems, reference is made to the documents WO 2015/097339 A1 and KR 102217173 B1 by way of example.

Irrespective of the exact geometric design of the plug connector element and the specifications of the further connection components, in accordance with the method for electrically contacting and heating a bipolar plate of a fuel cell according to the application, generally speaking, an electric current is permanently conducted between the plug connector element and the bipolar plate via at least one NTC heater element and, depending on the temperature, also via at least one bimetallic element, wherein the bimetallic element is suitable for restricting the function of the NTC heater element or also for virtually completely deactivating it. The temperature at which the switchover between the different states of the connection arrangement takes place is, for example, 80° C. to 90° C., wherein a hysteresis can be present.

### BRIEF DESCRIPTION OF THE DRAWINGS

In the following, an exemplary embodiment of the disclosure is explained in more detail with reference to drawings. In the drawings:

FIG. 1 shows an electrical connection arrangement on a bipolar plate of a fuel cell in a first state,

FIG. 2 shows the connection arrangement in a second state.

### DETAILED DESCRIPTION

A connection arrangement designated overall with the reference sign 1 is intended for use in a fuel cell system 18, which is used, for example, in a motor vehicle. The fuel cell system 18 comprises a plurality of bipolar plates 2, which are arranged in a stacked manner in accordance with a basic concept known per se. With regard to the basic structure and function of the fuel cell system 18, reference is made to the prior art cited at the outset.

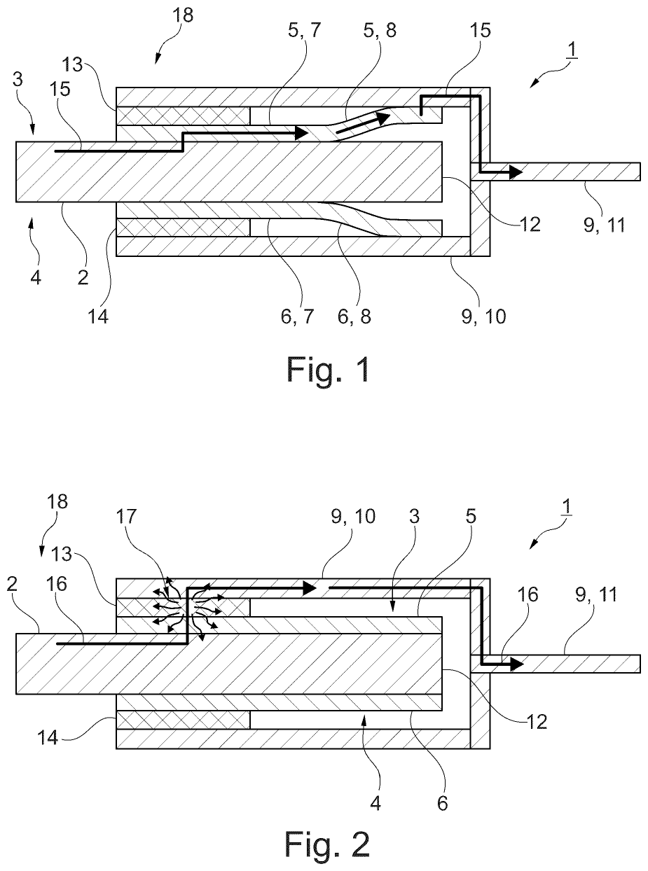

In the arrangement shown in FIGS. 1 and 2, the bipolar plate 2 has an upper side 3 and a lower side 4. The terms “upper side” and “lower side” do not imply any statement about the actual orientation of the bipolar plates 2 in a fuel cell stack. In particular, the bipolar plates 2 can be arranged in a vertical orientation in the fuel cell system 18.

On the upper side 3 and on the lower side 4 of the bipolar plate 2, one bimetallic element 5, 6 is provided in each case, which extends to the edge of the bipolar plate 2 designated with the reference sign 12. Each bimetallic element 5, 6 has a contact region 7, in which it permanently contacts the bipolar plate 2, and a deflectable region 8 adjoining the contact region 7, which extends to the edge 12. The regions 7, 8 are also referred to as sections of the bimetallic element 5, 6.

The connection arrangement 1 further includes a plug connector element 9, which is pushed onto the edge 12 of the bipolar plate 2. The plug connector element 9 has an open section 10, which surrounds the bipolar plate 12, as well as an adjoining connection section 11, which is to be connected to an electrical line not shown and which, in the exemplary embodiment, lies in the same plane as the center plane of the bipolar plate 2.

An NTC heater element 13, 14 is arranged in each case between the contact region 7 of each bimetallic element 5, 6 and an inner surface of the open section 10 of the plug connector element 9. The extent to which the NTC heater element 13, 14 becomes functionally effective depends on the temperature at which the connection arrangement 1, in particular the bipolar plate 2, is operated.

In the state shown in FIG. 1, the fuel cell system 18 is operated above a limit temperature, which in the present case is between 80° C. and 90° C. In this state, the regions 8 of the bimetallic elements 5, 6 are deflected so that they contact the section 10 of the plug connector element 9. In this case, a current path designated with the reference sign 15 from the bipolar plate 2 to the connection section 11 leads through the deflectable regions 8 of the bimetallic elements 5, 6, as indicated by way of example on the upper side 3 in FIG. 1. The comparatively high electrical resistance of the NTC heater elements 13, 14 means that only a very low electric current flows through the elements 13, 14. Heating by the NTC heater elements 13, 14 therefore practically does not take place in the state shown in FIG. 1.

In the state shown in FIG. 2, the temperature is below the specified limit temperature. In particular, this can be a temperature below 0° C. Due to this low temperature compared to the configuration shown in FIG. 1, the bimetallic elements 5, 6 are completely in contact with the bipolar plate 2 so that they are spaced apart from the plug connector element 9. The current path designated with the reference sign 16 in this case thus inevitably leads through the NTC heater elements 13, 14. Heat generation zones 17 are thus formed in the NTC heater elements 13, 14, which are only indicated on the upper side 3 in FIG. 2. Heat is introduced into the bipolar plate 2 and thus into the entire fuel cell system 18 via the heat generation zones 17.

This heat input, also supported by heat generation in the individual fuel cells of the fuel cell system 18, continues until the aforementioned limit temperature is exceeded, so that the state outlined in FIG. 1 occurs, i.e., the heating by the NTC heater elements 13, 14 is stopped. A particular advantage of the connection arrangement 1 is that the bipolar plate 2 is heated as required without the need for separate control-engineering components.

### LIST OF REFERENCE SIGNS

Connection arrangement
Bipolar plate
Upper side
Lower side
Bimetallic element
Bimetallic element
Contact region of the bimetallic element
Deflectable region of the bimetallic element
Plug connector element
Open section of the plug connector element
Connection section
Edge of the bipolar plate
NTC heater element
NTC heater element
First current path
Second current path
Heat generation zone
Fuel cell system

1. An electrical connection arrangement for a bipolar plate of a fuel cell, comprising:
at least one bimetallic element connected to the bipolar plate,
an NTC heater element, and
an electrically conductive plug connector element provided for placement on the bipolar plate, wherein an electrically conductive connection is established between the bipolar plate and the plug connector element via the NTC heater element when the plug connector element is plugged onto the bipolar plate, and a connection connected electrically in parallel with the NTC heater element is established only in a predetermined temperature range via the bimetallic element.

2. The connection arrangement according to claim 1, wherein the NTC heater elements are arranged on both sides of the bipolar plate inside the plug connector element.

3. The connection arrangement according to claim 2, wherein the bimetallic elements are arranged on both sides of the bipolar plate.

4. The connection arrangement according to claim 3, wherein each bimetallic element has a section which is arranged between the bipolar plate and one of the NTC heater elements.

5. The connection arrangement according to claim 3, wherein the arrangements each consisting of a bimetallic element and an NTC heater element are positioned mirror-symmetrically to the center plane of the bipolar plate.

6. The connection arrangement according to claim 5, wherein each bimetallic element has a deflectable section provided for contacting an inner surface of the plug connector element.

7. The connection arrangement according to claim 6, wherein the deflectable sections of the bimetallic elements terminate flush with an edge of the bipolar plate.

8. A method for electrically contacting and heating a bipolar plate of a fuel cell, comprising:
conducting, permanently, an electric current is between a plug connector element and the bipolar plate via at least one NTC heater element and, depending on a temperature, also via at least one bimetallic element.

9. The method according to claim 8, wherein the electrical connection and disconnection of the bimetallic element occurs in a temperature range of 80° C. to 90° C.

10. The method according to claim 8, wherein, after establishing an electrically conductive connection between the bimetallic element and the plug connector element, no more than 5% of a total electric current flowing between the bipolar plate and the plug connector element is conducted through the at least one NTC heater element.
